(19) United States
(12) Patent Application Publication
(10) Pub. No.: US 2007/0044110 A1
(43) Pub. Date: Feb. 22, 2007

(54) Disk clamping apparatus

(75) Inventor: Takeshi Kurita, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/503,231

(22) Filed: Aug. 14, 2006

(30) Foreign Application Priority Data
Aug. 22, 2005 (JP) 2005-239563

(51) Int. Cl. G11B 17/04

(52) U.S. Cl. 720/604

(57) ABSTRACT

There is provided a disk clamping apparatus capable of preventing abnormal noise and/or chucking error with a simple structure. A tapered surface 1aa opened upward is provided in the entire inner peripheral edge portion at the lower part of a housing 1a in a clamper holder 1. Then, the tapered surface is adapted to guide and center a clamper 2. It is specifically arranged that when the clamper 2 is displaced with respect to the center position, the flange portion 2a thereof once gets on the tapered surface 1aa, but subsequently slides down along the tapered surface 1aa, whereby the clamper 2 is centered automatically.

### BACKGROUND OF THE INVENTION

1. Field of the Invention

The present invention relates to a disk clamping apparatus, particularly for holding a disk rotated by a spindle motor.

2. Description of the Prior Art

In units for driving such an optical disk as typified by CD, DVD, or the like, there has conventionally been used a disk clamping apparatuses for holding a disk rotated by a spindle motor. FIG. 3 is a view showing an example of a conventional disk clamping apparatus, where FIG. 3(a) is a plan view and FIG. 3(b) is a left side cross-sectional view. As shown in the figure, in the center of an approximately long plate-shaped clamper holder 100, there is provided an approximately circular housing 100a, in which an approximately disk-shaped clamper 101 is inserted loosely and installed rotatably. It is noted that FIG. 3(a) is drawn in such a manner as to allow the clamper 101 provided inside the housing 100a to be shown.

Specifically, a flange portion 101a that is provided in a protruding manner outward in the radial direction of the clamper 101 is engaged with engaging portions 100b that are provided in a protruding manner inward from a plurality of portions on the inner peripheral edge portion at the lower part of the housing 100a. In this case, when a disk is chucked with a turntable not shown in the figure, the clamper 101 is pushed up and raised by the turntable so that the flange portion 101a is apart from the engaging portions 100b and the clamper 101 becomes rotatable. Meanwhile, at the upper part of the housing 100a, there is provided a ceiling portion 100c to prevent the clamper 101 from jumping out of the housing 100a.

FIG. 4 is an enlarged vertical cross-sectional view showing the shape of the above-described conventional turntable and clamper. This figure is drawn to show a state where the clamper 101 is positioned directly above the turntable 102. As mentioned above, the flange portion 101a is provided in a protruding manner outward in the radial direction of the clamper 101. Also, a ring-shaped clamping portion 101b extends downward from the portion where the flange portion 101a extends in the clamper 101. The disk not shown in the figure is adapted to be clamped between the clamping portion 101b and the upper surface of the turntable 102.

Further, hook portions 101c extend downward from a plurality of portions on the lower surface between the peripheral part and the central part of the clamper 101. The hook portions 101c hold magnets not shown in the figure in an engaging manner, which generates a force for clamping the disk. In addition, a columnar boss 101d extends downward from the lower surface in the central part of the clamper 101, which is used for axial alignment with the turntable 102.

Meanwhile, in the central part of the upper surface of the approximately disk-shaped turntable 102, there is provided a fitting portion 102a in a protruding manner that is adapted to be fitted into the center hole of the disk. In the outer peripheral edge portion at the upper part of the fitting portion 102a, there is provided a tapered surface 102aa adapted to guide the center hole of the disk for easy fitting to the fitting portion 102a. It is noted that a ring-shaped fixing plate 103 made of, for example, iron is embedded between the peripheral part and the central part of the fitting portion 102a. This generates a clamping force due to magnetism with the foregoing magnets to clamp the disk.

Further, in the central part of the lower surface of the turntable 102, there is provided a columnar boss 102b in a protruding manner, at the center of which is opened an axial hole 102ba to which the rotation axis of a spindle motor not shown in the figure is to be fitted. The axial hole 102ba communicates with a fitting hole 102ab that is opened at the center of the fitting portion 102a, and the boss 101d of the clamper 101 is to be fitted into the fitting hole 102ab, when clamping the disk, for axial alignment with the turntable 102. It is noted that the upper part of the fitting hole 102ab is opened in a tapered manner for easy guiding and fitting of the boss 101d.

In addition to above, Japanese Patent Laid-Open Publication No. 2004-118962 describes a disk reproducing apparatus in which the rotation axis of a clamper can be aligned precisely with the rotation axis of a turntable without ensuring a clearance for compensation for misalignment between the rotation axis of the clamper and the rotation axis of the turntable.

It is specifically arranged that a clamper holding hole portion is provided in clamper holding means for penetrating through a clamper as well as the outer shape of the clamper is formed in a tapered manner, and when penetrated partially, the clamper holding hole portion, that is, the edge line thereof is brought into contact with the taper for automatic axial alignment, and that the clamper is engaged with the turntable by forming such a state so that the rotation axis of the clamper can be aligned precisely with the rotation axis of the turntable.

Also, Japanese Patent Laid-Open Publication No. 2003-203410 discloses a disk clamping mechanism in which sideslip caused by a centrifugal force during high-speed rotation due to displacement of the center of gravity of a disk is solved for maintaining of robust centering even when applied to a high-speed rotation.

Specifically, in the disk clamping mechanism in which a disk medium is centered by a pressing part provided in the central part of a turntable that is fixed to the rotation axis of a spindle motor to press the peripheral edge of the center hole of the disk medium and the disk medium is pressed and clamped against the turntable by a clamper, the clamper is provided with a protrusion for pressing the peripheral edge of the center hole of the disk medium.

Further, Japanese Patent Laid-Open Publication No. 2003-157600 discloses a clamping mechanism and a disk apparatus capable of addressing the application of high-speed rotation reliably without increase in size or cost, etc. It is specifically arranged that a center hub does not protrude downward from a clamper during mounting of a disk onto a turntable, while the center hub protrudes downward from the clamper when the disk is mounted on the turntable.

In addition, Japanese Patent Laid-Open Publication No. 2002-269878 discloses a disk drive unit in which a clamper axis aligning mechanism neither inhibits the reduction in the thickness of the unit nor generates harsh abnormal noise in a clamping operation. It is specifically arranged that there is provided a clamper axis aligning hub supported elastically around the rotation axis of a drive motor and vertically movably along the axial direction of the rotation axis, and when the clamper presses the clamper axis aligning hub in a clamping operation, the clamper axis aligning hub centers the clamper using a tapered surface as a guide surface while moving downward elastically.

However, since such a conventional arrangement as shown in FIGS. 3 and 4 has a structure in which the clamper 101 is likely to be displaced with respect to the center position, the clamper 101 may get on the fitting portion 102a of the turntable 102, for example, when chucking a disk. In this case, the clamper 101 is lifted by the turntable 102 while getting on the fitting portion 102a with the progress of the chucking, resulting in that the clamper 101 is brought into contact with the ceiling portion 100c of the clamper holder 100.

In the case above, the clamper 101 is to be pressed down by the ceiling portion 100c, and then the clamper 101 sticks swiftly to the turntable 102, resulting in abnormal noise. Such abnormal noise, if occurred, may result in not only bringing discomfort to users but also scratching the disk and/or abrading the clamper and/or turntable. Further, the disk may not be clamped normally, resulting in a chucking error.

In addition to above, such arrangements as described in the foregoing patent documents are adapted only to align the axes of the turntable and the clamper but to prevent abnormal noise and/or chucking error due to displacement of the clamper itself.

### SUMMARY OF THE INVENTION

The present invention has been made in consideration of the above-described problems, and an object thereof is to provide a disk clamping apparatus capable of preventing abnormal noise and/or chucking error with a simple structure.

In order to achieve the foregoing object, the present invention is directed to a disk clamping apparatus including: a clamper adapted to clamp a disk with a turntable to be rotated and to be rotated together with the turntable and the disk; and a clamper holder in which the clamper is inserted loosely and held rotatably in a housing, wherein a tapered surface opened upward is provided in the inner peripheral edge portion of the housing, the tapered surface being adapted to guide and center the clamper.

Also, the apparatus is characterized in that the clamper is adapted to clamp a disk with the turntable and to be rotated together with the turntable and the disk by applying a magnetic force.

Alternatively, the apparatus is characterized in that the clamper is adapted to clamp a disk with the turntable and to be rotated together with the turntable and the disk by applying a clamping force generated by providing a protrusion in the central part of the upper surface of the clamper and urging the protrusion downward.

In accordance with the present invention, it is possible to provide a disk clamping apparatus capable of preventing abnormal noise and/or chucking error with a simple structure.

### BRIEF DESCRIPTION OF THE DRAWINGS

FIG. 1 is a view showing a disk clamping apparatus according to a first embodiment of the present invention;

FIG. 2 is an enlarged view of the section A in FIG. 1(b);

FIG. 3 is a view showing an example of a conventional disk clamping apparatus; and

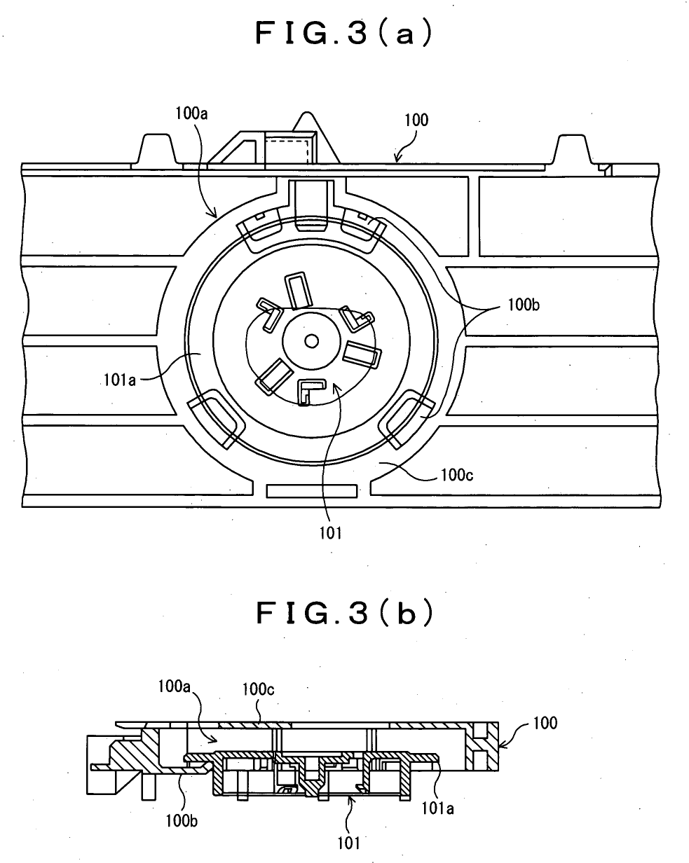

FIG. 4 is an enlarged vertical cross-sectional view showing the shape of a conventional turntable and clamper.

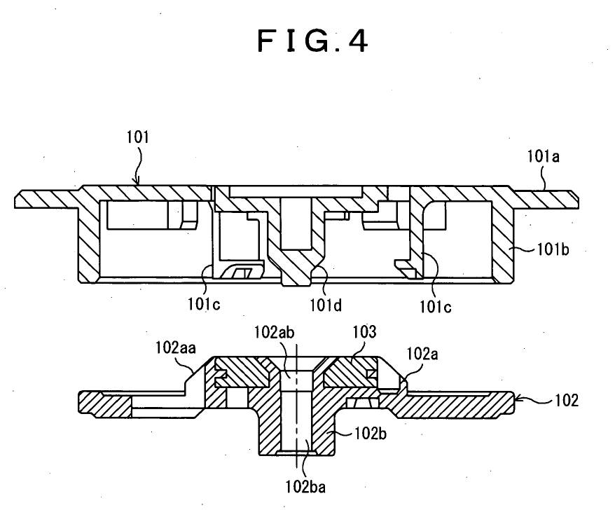

### DESCRIPTION OF THE PREFERRED EMBODIMENTS

An embodiment of the present invention will hereinafter be described with reference to the accompanying drawings.

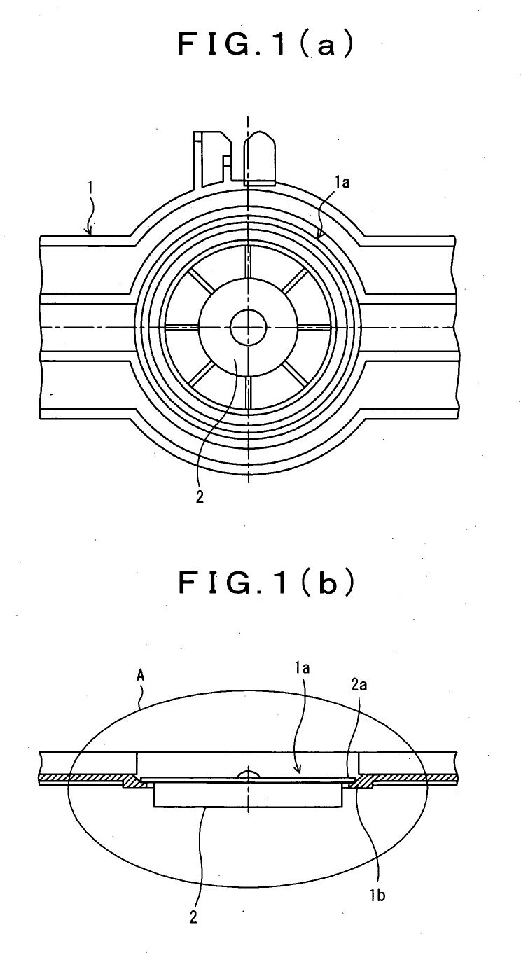

FIG. 1 is a view showing a disk clamping apparatus according to a first embodiment of the present invention, where FIG. 1(a) is a plan view and FIG. 1(b) is a front cross-sectional view. As shown in the figure, in the center of an approximately long plate-shaped clamper holder 1, there is provided an approximately circular housing 1a, in which an approximately disk-shaped clamper 2 is inserted loosely and installed rotatably. It is noted that the material of the clamper holder 1 and the clamper 2 is assumed to be resin, but may be metal, etc. if possible.

Specifically, a flange portion 2a that is provided in a protruding manner outward in the radial direction of the clamper 2 is engaged with a ring-shaped receiving portion 1b that is provided in a protruding manner inward from the entire inner peripheral edge portion at the lower part of the housing 1a. In this case, when a disk is chucked with a turntable not shown in the figure, the clamper 2 is pushed up and raised by the turntable so that the flange portion 2a is apart from the receiving portion 1b and the clamper 2 becomes rotatable.

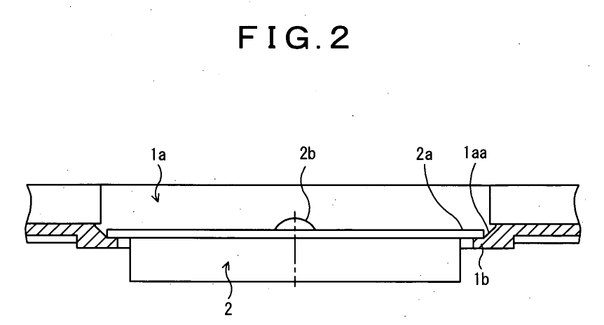

FIG. 2 is an enlarged view of the section A in FIG. 1(b), that is, an enlarged front cross-sectional view. As shown in the figure, in the present embodiment, a tapered surface 1aa opened upward is provided in the entire inner peripheral edge portion at the lower part of the housing 1a. The tapered surface is positioned at the base of the receiving portion 1b and is then adapted to guide and center the clamper 2. It is specifically arranged that when the clamper 2 is displaced with respect to the center position, the flange portion 2a once gets on the tapered surface 1aa, but subsequently slides down along the tapered surface 1aa, whereby the clamper 2 is centered automatically. However, the tapered surface 1aa may not necessarily be provided in the entire periphery.

If the clamper 2 is centered preliminarily as mentioned above, the clamper 2 can perform smooth clamping without getting on the fitting portion of the turntable (not shown in the figure) even when a chucking operation may be performed. It is therefore possible to prevent abnormal noise and/or chucking error reliably. It is noted that the inner structure of the clamper 2 and the structure of the turntable according to the present embodiment are omitted in the figures.

The present embodiment is also arranged in such a manner, as shown in FIG. 2, that a clamping force is generated with the turntable by providing a protrusion 2b in the central part of the upper surface of the clamper 2 and urging the top thereof downward using, for example, an elastic member not shown in the figure. However, it will be appreciated that without restricting to such an arrangement, the clamping force may be generated using magnets and a fixing plate as in the above-described conventional arrangement.

As described heretofore, in accordance with the present invention, it is possible to provide a disk clamping apparatus capable of preventing abnormal noise and/or chucking error with a simple structure in which a clamper is guided and centered by a tapered surface.

What is claimed is:

1. A disk clamping apparatus comprising: a clamper adapted to clamp a disk with a turntable to be rotated and to be rotated together with said turntable and said disk; and a clamper holder in which said clamper is inserted loosely and held rotatably in a housing, wherein
a tapered surface opened upward is provided in the inner peripheral edge portion of said housing, a flange portion extending outward in the radial direction of said clamper being adapted to slide down along said tapered surface so that said clamper is centered, and wherein
said clamper is adapted to clamp a disk with said turntable and to be rotated together with said turntable and said disk by applying a magnetic force or a clamping force generated by providing a protrusion in the central part of the upper surface of said clamper and urging said protrusion downward.

2. A disk clamping apparatus comprising: a clamper adapted to clamp a disk with a turntable to be rotated and to be rotated together with said turntable and said disk; and a clamper holder in which said clamper is inserted loosely and held rotatably in a housing, wherein
a tapered surface opened upward is provided in the inner peripheral edge portion of said housing, said tapered surface being adapted to guide and center said clamper.

3. The disk clamping apparatus according to claim 2, wherein said clamper is adapted to clamp a disk with said turntable and to be rotated together with said turntable and said disk by applying a magnetic force.

4. The disk clamping apparatus according to claim 2, wherein said clamper is adapted to clamp a disk with said turntable and to be rotated together with said turntable and said disk by applying a clamping force generated by providing a protrusion in the central part of the upper surface of said clamper and urging said protrusion downward.
